(19) United States
(12) Patent Application Publication
(10) Pub. No.: US 2020/0206088 A1
(43) Pub. Date: Jul. 2, 2020

(54) BOTTLE FOR FEEDING AND A METHOD OF MANUFACTURING THEREOF

(71) Applicant: HUGOPAK PTY LTD, South Hurstville, New South Wales (AU)

(72) Inventor: Shane SIPTHORP, South Hurstville, New South Wales (AU)

(21) Appl. No.: 16/648,401

(22) PCT Filed: Dec. 4, 2017
(86) PCT No.: PCT/AU2017/051329

§ 371 Date: Mar. 18, 2020

(30) Foreign Application Priority Data
Oct. 24, 2017 (AU) 2017904299

(51) Int. Cl. A61J 9/08; A61J 11/00; B29C 49/04; B29C 49/42; A23L 33/00

(52) U.S. Cl. CPC A61J 9/08; A61J 11/008; B29K 2101/12; B29C 49/4273; A23L 33/40; B29C 49/04

(57) ABSTRACT

A bottle for feeding includes a body defining an enclosed cavity, where the body has a base and a top end. The enclosed cavity contains a liquid. A teat provided at the top end is adapted for discharging the liquid. A closure provided on the teat is adapted for hermetically and aseptically sealing the teat, before use and after the bottle has been manufactured. Also, a method of manufacturing the bottle for feeding is disclosed.

### TECHNICAL FIELD

The present invention generally relates to formula feeding for infants and in particular to a bottle for feeding and a method of manufacturing thereof.

### BACKGROUND

Formula feeding of babies and infants is necessary for a number of reasons including convenience and medical reasons. For instance, if a mother is unable to breast feed and/or is unavailable and/or the baby is unable to feed naturally.

Baby or infant formula is a manufactured food that is designed to provide a full food replacement of human mothers milk for babies and infants. Infant formulas come in powder, liquid concentrate, and ready-to-feed forms. They are designed to be prepared by the parent or caregiver in small batches and fed to the infant, usually with either a cup or a baby bottle.

Several types of infants formula are available such as, Cow's Milk Formula, Soy Protein based Formulas and Protein Hydrolysate Formulas. Cow's Milk Formula is the most common and has been altered to resemble breast milk. Further, Soy Protein based formulas are used for infants having allergic to cow's milk or lactose. Soy-based formulas can also be useful if a parent wants to exclude animal proteins from the child's diet Also, Protein Hydrolysate Formulas contain protein that is been broken down into smaller sizes than are those in cow's milk and soy-based formulas. Protein Hydrolysate formulas are meant for babies who unable to digest cow's milk or soy-based formulas. Moreover, specialized formulas are also available for premature infants and those with specific medical conditions.

It is desirable to measure powders or concentrates accurately to achieve the intended final product concentration. In case, the measurement is not done properly, the child could become malnourished or may suffer from other medical conditions. Further, all equipment (like teat or body of bottle or the like) that comes in contact with the infant formula needs be cleaned and sterilized before each use. Additionally, proper refrigeration is also essential for any infant formula which is prepared in advance.

Additionally, in some less developed countries infant formula is often prepared improperly, resulting in high infant mortality due to malnutrition and diseases such as diarrhea and pneumonia. This is made worse in some instances due to lack of clean water, lack of sterile conditions, lack of refrigeration, illiteracy (so written instructions cannot be followed), poverty (diluting formula so that it lasts longer), and lack of education of mothers.

It is therefore desirable to have a bottle for feeding and a method of manufacturing thereof that provides a simple and efficient solution to the deficiencies of the prior art or at least provides a useful alternative.

Throughout this specification, unless the context requires otherwise, the words ‘comprise, ‘comprises and ‘comprising will be understood to imply the inclusion of a stated step or element or group of steps or elements but not the exclusion of any other step or element or group of steps or elements.

Any one of the terms: ‘including or ‘which includes or ‘that includes as used herein is also an open term that also means including at least the elements/features that follow the term, but not excluding others.

Any discussion of the background art throughout the specification should in no way be considered as an admission that such background art is prior art nor that such background art is widely known or forms part of the common general knowledge in the field in Australia or worldwide.

### SUMMARY

According to first aspect of the present invention, a bottle for feeding is provided. The bottle for feeding, comprises a body defining an enclosed cavity, the body having a base and a top end, the enclosed cavity having pre-mixed and pre-filled formula, a teat provided at the top end, the teat being adapted for discharging the formula, in use and a closure provided on the teat, being adapted for hermetically and aseptically sealing the teat, before use and after the bottle has been manufactured.

It is advantageous that the bottle for feeding eliminates the need of expensive logistics such as, but not limited to, cleaning and sterilization of bottles which is a time consuming process. The bottle for feeding is beneficial for mothers who are unable to read the instructions written on the available bottles. Also, a mother knows exactly what her baby's intake of milk is or how much milk her baby has had. Additionally, the mother need not to be present each time the baby has to be fed; some other family member or friend can also feed the baby. Moreover, a social life of the mother does not need to be curtailed. She can resume her normal life by using bottle-feeding.

The body, the teat and the closure may be provided in a single combined form.

The closure may be selected from a group consisting of a twist type closure, a twist and puncture type closure and a puncture type closure.

The bottle may further comprise a cap provided onto the closure.

The bottle may further comprise an insulated cover provided onto the bottle.

The insulated cover may further comprise an opening mechanism.

The opening mechanism may be a zipper.

The zipper material may be selected from a group comprising a plastic material and a metallic material.

According to another aspect of the present invention, a method for manufacturing a bottle for feeding is disclosed. The method comprises steps of extruding a parison from fused raw material and positioning the parison in an open mould, the open mould having an upper portion and a lower portion, closing the lower portion, the closing of the lower portion resulting in closing of the parison at one end and formation of a base of the bottle, applying pressurized air into the parison and/or applying a vacuum to the lower portion, resulting in the parison taking a shape of the lower portion and forming a body of the bottle, the body defining an enclosed cavity, feeding a predetermined amount of formula into the enclosed cavity; and closing the upper portion of the mould, resulting in formation of a teat and a closure in a combined form at a top end of the bottle.

The above mentioned method may offer a number of advantages. The method allows for a much wider variety of sizes, shapes and neck openings. The above method of producing the bottle is less expensive and is less time consuming.

The raw material may be a polymer material.

The pressurized air may be sterilized before being applied into the parison.

The closure may be selected from a group consisting of a twist type closure, a twist and puncture type closure and a puncture type closure.

The method may further comprise a step of providing a cap onto the closure, the cap being sterilized before being provided onto the closure.

The method may further comprise a step of providing an insulated cover onto the bottle.

The insulated cover may further comprise an opening mechanism.

The opening mechanism may be a zipper.

The zipper material may be selected from a group comprising a plastic material and a metallic material.

The body, the teat and the closure may be formed in a single combined form.

According to yet another aspect of the invention, there is provided a bottle for feeding, the bottle comprising: a body defining an enclosed cavity, the body having a base and a top end, the enclosed cavity containing a liquid; a teat provided at the top end, the teat being adapted for discharging the liquid, in use; and a closure provided on the teat, being adapted for hermetically and aseptically sealing the teat, before use and after the bottle has been manufactured.

The liquid may be any suitable liquid for consumption including: water; formula; rehydrating fluid; juice.

According to yet another aspect of the invention, there is provided a method of manufacturing a bottle for feeding, the method comprising: extruding a parison from fused raw material and positioning the parison in an open mould, the open mould having an upper portion and a lower portion; closing the lower portion, the closing of the lower portion resulting in closing of the parison at one end and formation of a base of the bottle; applying pressurized air into the parison and/or applying a vacuum to the lower portion, resulting in the parison taking a shape of the lower portion and forming a body of the bottle, the body defining an enclosed cavity; feeding a predetermined amount of liquid into the enclosed cavity; and closing the upper portion of the mould, resulting in formation of a teat and a closure in a combined form at a top end of the bottle.

The liquid may be any suitable liquid for consumption including: water; formula; rehydrating fluid; juice.

According to yet another aspect of the invention, there is provided a bottle for feeding, the bottle comprising: body defining an enclosed cavity, the body having a base and a top end, the enclosed cavity containing a liquid; a teat being adapted for discharging the liquid, in use; and a closure being adapted for hermetically and aseptically sealing the teat, before use and after the bottle has been manufactured.

According to yet another aspect of the invention, there is provided a method of manufacturing a bottle for feeding, the method comprising: extruding a parison from fused raw material and positioning the parison in an open mould, the open mould having an upper portion and a lower portion; closing the lower portion, the closing of the lower portion resulting in closing of the parison at one end and formation of a base of the bottle; applying pressurized air into the parison and/or applying a vacuum to the lower portion, resulting in the parison taking a shape of the lower portion and forming a body of the bottle, the body defining an enclosed cavity; feeding a predetermined amount of formula into the enclosed cavity; closing the upper portion of the mould; forming a teat in a combined form at one end of the bottle.

### BRIEF DESCRIPTION OF DRAWINGS

At least one example of the invention will be described with reference to the accompanying drawings, in which:

FIG. 1 illustrates a bottle for feeding, in accordance with an embodiment of the present invention;

FIG. 2 illustrates a method of manufacturing a bottle for feeding, in accordance with an embodiment of the present invention;

FIG. 3A illustrates a step of FIG. 2, in accordance with an embodiment of the present invention;

FIG. 3B illustrates another step of FIG. 2, in accordance with an embodiment of the present invention;

FIG. 3C illustrates yet another step of FIG. 2, in accordance with an embodiment of the present invention;

FIG. 3D illustrates yet another step of FIG. 2, in accordance with an embodiment of the present invention;

FIG. 3E illustrates yet another step of FIG. 2, i n accordance with an embodiment of the present invention;

FIG. 3F illustrates yet another step of FIG. 2, in accordance with an embodiment of the present invention;

FIG. 4 illustrates an exemplary bottle with a cap onto a closure, in accordance with an embodiment of the present invention;

FIG. 5A illustrates a way for opening the cap of the bottle for feeding, in accordance with an embodiment of the present invention;

FIG. 5B illustrates the bottle after opening of the cap, in accordance with an embodiment of the present invention;

FIG. 6A-6C illustrate a twist type closure, a puncture type closure and a twist and puncture type closure of the bottle respectively, in accordance with an embodiment of the present invention;

FIG. 6D-6E illustrate a second twist and puncture type closure for the bottle, in accordance with another embodiment of the present invention;

FIG. 7A illustrates the bottle after opening the teat using the closure, in accordance with an embodiment of the present invention;

FIG. 7B illustrates a baby being fed through the bottle, in accordance with an embodiment of the present invention;

FIG. 8A illustrates the bottle for feeding enclosed in a cover, in accordance with an embodiment of the present invention; and

FIG. 8B illustrates a way of removing the cover from the bottle, in accordance with an embodiment of the present invention.

It should be noted in the accompanying drawings and description below that like or the same reference numerals in different drawings denote the same or similar elements.

### DESCRIPTION OF EMBODIMENTS

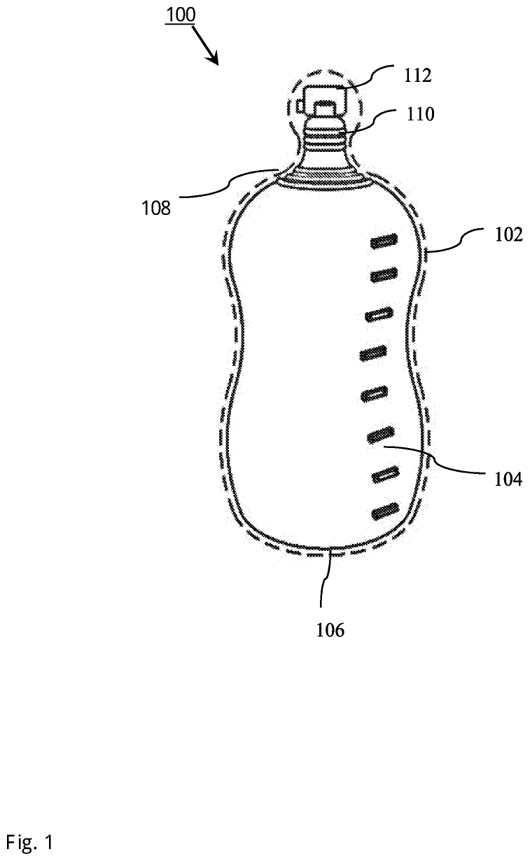

Referring to FIG. 1, which illustrates a bottle 100 for feeding. The bottle 100 for feeding includes a body 102 defining an enclosed cavity 104, the body 102 having a base 106 and a top end 108. The enclosed cavity 104 contains a liquid. Also, the liquid may be selected from a group consisting of, but not limited to, water, juice, rehydrating fluid, pre mixed and prefilled formula. Also, a teat 110 is provided at the top end 108. The teat 110 is adapted for discharging the liquid, in use. The teat 110 is designed so as to support feeding and may be designed for particular applications for example to reduce an amount of air a baby takes in, while feeding. If the baby inhales excess air this may result in a syndrome termed as colic where the baby cries excessively and may not be soothed. Further, a closure 112 is provided on the teat 110. The closure 112 is adapted for hermetically and aseptically sealing the teat 110, before use and after the bottle 100 has been manufactured. Also, hermetic sealing means for preventing fluid permeation to and from the bottle 100. Additionally, the closure 112 is selected from a group consisting of, but not limited to, a twist type closure 112, a twist and puncture type closure and a puncture closure. Herein, the twist type closure 112 provided on the teat 110.

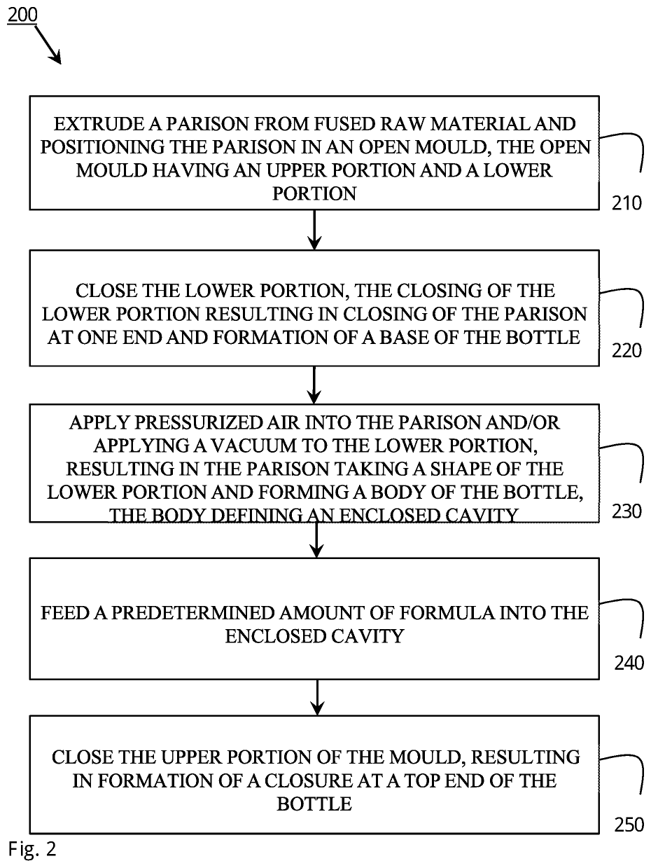

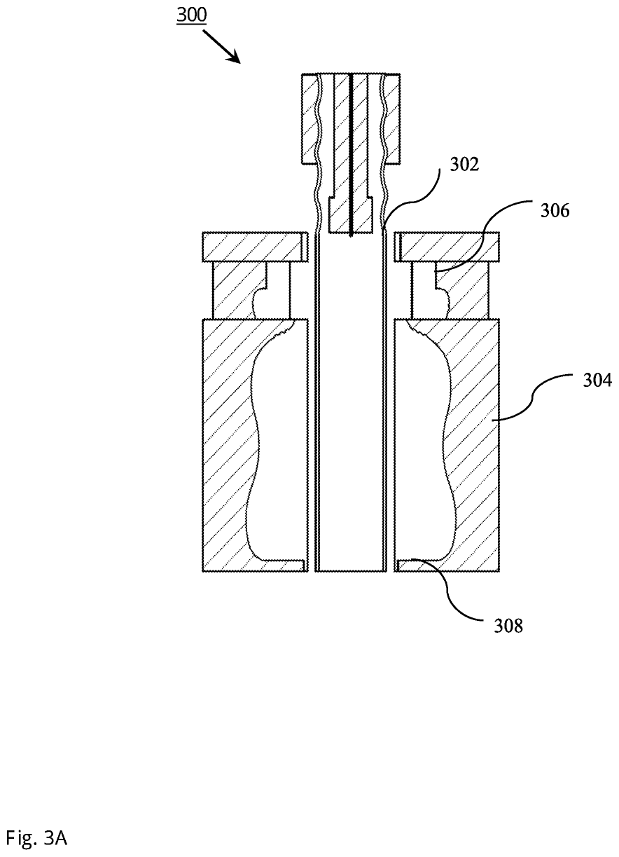

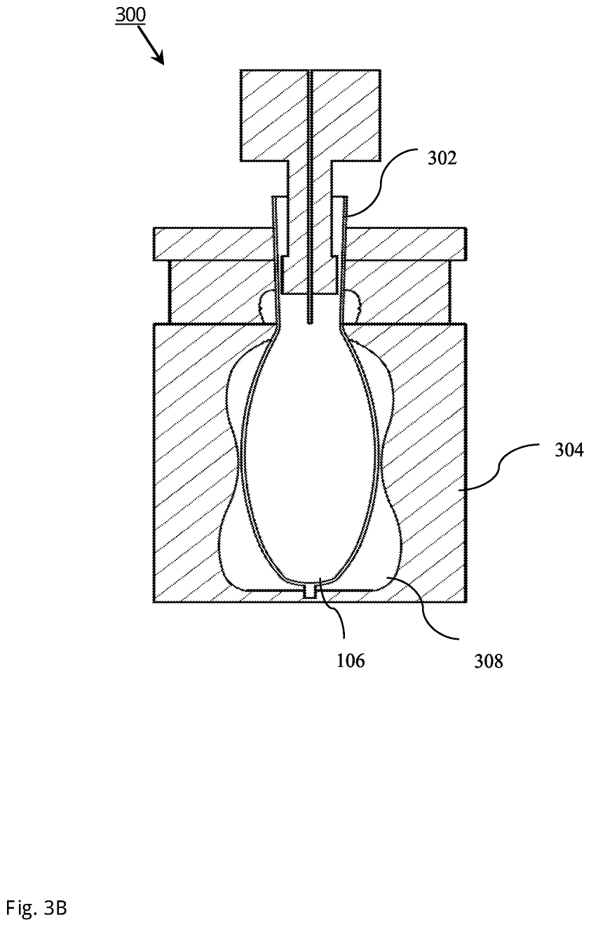

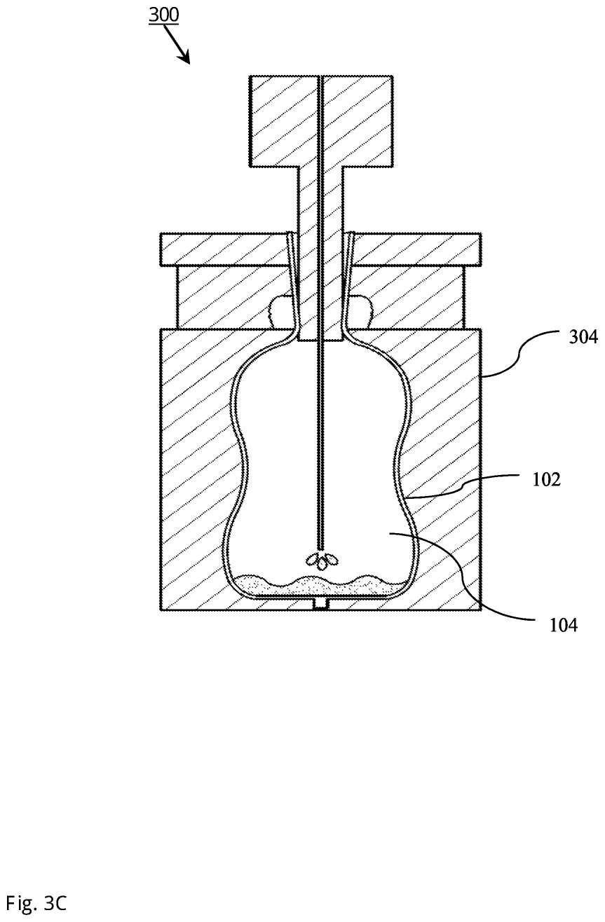

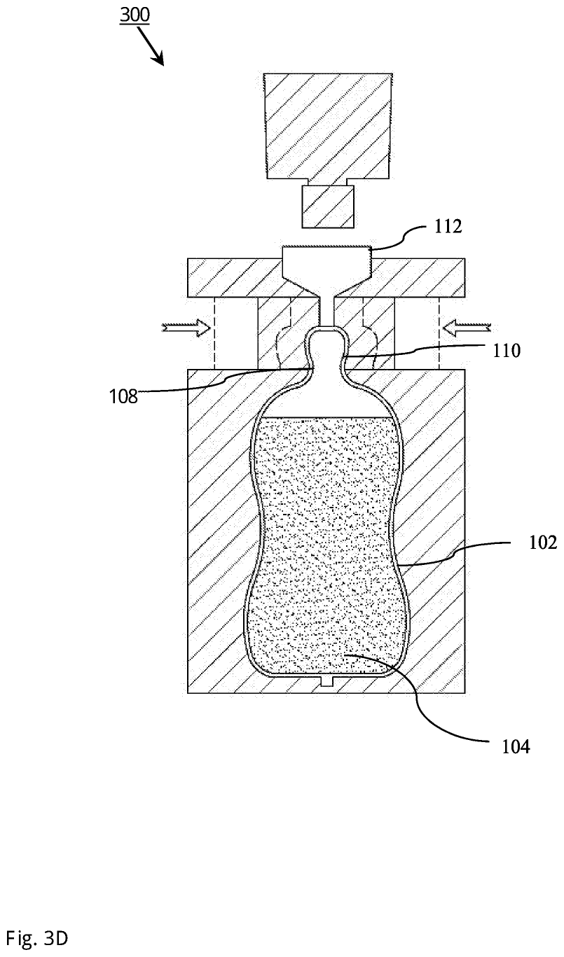

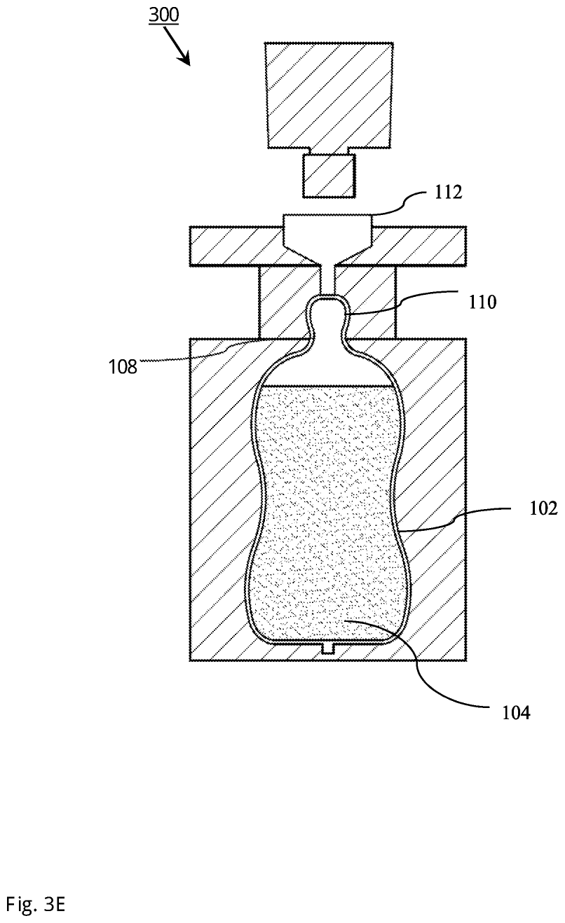

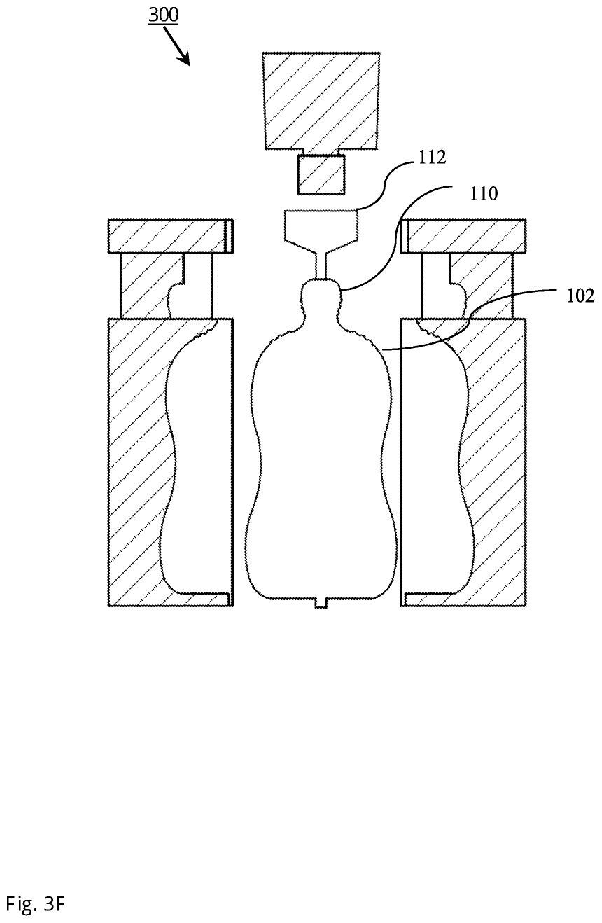

FIG. 2 illustrates a method 200 of manufacturing a bottle 100 for feeding. The method 200 begins at step 210, by extruding a parison 302 from a fused raw material. The parison 302 may be a hollow tube of plastic to be formed into a hollow object, such as a bottle or the like, by blow moulding. The raw material may be a polymer material. A skilled addressee would appreciate that the polymer material used may be any other food grade raw material for example Polypropylene (PP), Polyethylene (PE), Polyethylene—Terephthalate (PET) and Polyvinyl chloride (PVC) depending upon application. The step 210 is achieved by a mandrel containing a screw, placed inside a barrel 304 on the extruder, turning continuously and pushing a plastic down a length of the barrel 304. Further, the plastic is transformed from a solid pellet form into a molten state that allows the plastic to be formed into shapes, through mechanical friction. Additionally, heaters on the barrel 304 and head maintain a uniform temperature, creating material consistency, as the plastic moves through the barrel 304. The evenly heated molten plastic is then pushed through an extrusion head and past a die tooling that forms the parison 302. Further, the parison 302 may be positioned in an open mould as shown in FIG. 3A, in accordance with an embodiment 300 of the present invention. The open mould is having an upper portion 306 and a lower portion 308.

At step 220, the lower portion 308 of the open mould is closed. The closing of the lower portion 308 results in closing of the parison 302 at one end and thus a base 106 of the bottle 100 is formed as shown in FIG. 3B, in accordance with the embodiment 300 of the present invention.

At step 230, the mandrel is positioned on the neck of the barrel 304 and pressurized air is applied into the parison 302. In addition, a vacuum may be applied to the lower portion 308. The pressurized air may be sterilized before being applied into the parison 302. This may result in the parison 302 taking a shape of the lower portion. Hence, a body 102 of the bottle 100 may be formed. Further, the body 102 defines an enclosed cavity 104.

At step 240, referring to FIG. 3C, a predetermined amount of the liquid is fed into the enclosed cavity 104 via the mandrel. The liquid fed may be free from allergy and easily digested to baby. Also, the liquid fed is mixed properly and ready for consumption. It is envisaged here that the predetermined amount may be electronically controlled by means of controllers controlling the process.

At step 250, the upper portion 306 of the mould is closed which results in a formation of a teat 110 and a closure 112 at a top end 108 of the bottle 100 as shown in FIGS. 3D and 3E, in accordance with the embodiment 300 of the present invention. FIGS. 3D and 3E illustrate the formation of the teat 110 and the closure 112 in the combined form as the upper portion 306 closes and the parison 302 takes the form of an internal cavity of the upper portion 306 with or without the application of the pressurised air as per various alternative embodiments. Also, the closure 112 may be selected from a group consisting of a twist type closure 112, a twist and puncture type closure and a puncture type closure. Additionally, the bottle 100 is trimmed and removed from the mould as shown in FIG. 3E and the next cycle for manufacturing of the bottle 100 begins.

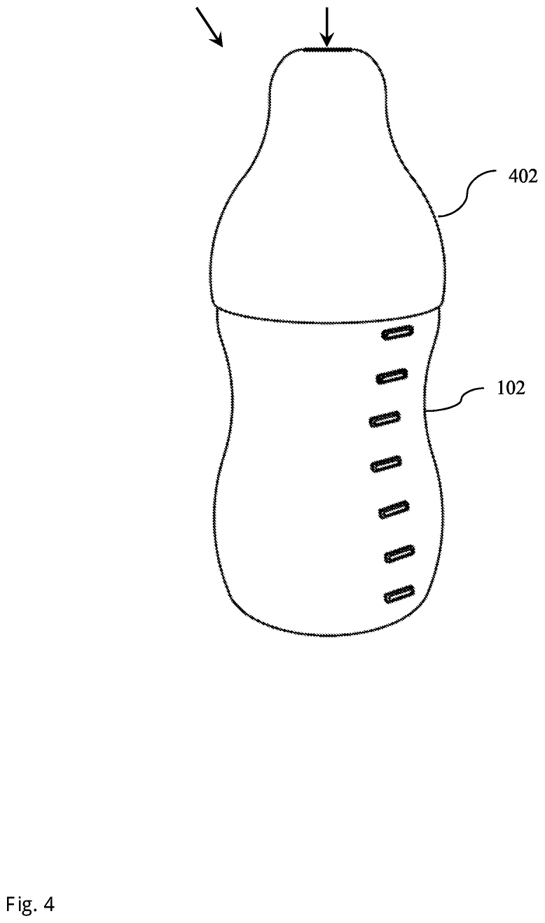

FIG. 4 illustrates an exemplary bottle 100 with a cap onto a closure 112, in accordance with an embodiment 400 of the present invention. As shown in FIG. 4, a cap 402 is provided on the body 102 of the bottle 100. The cap 402 is provided to cover the teat 110 and may be an optionally liner.

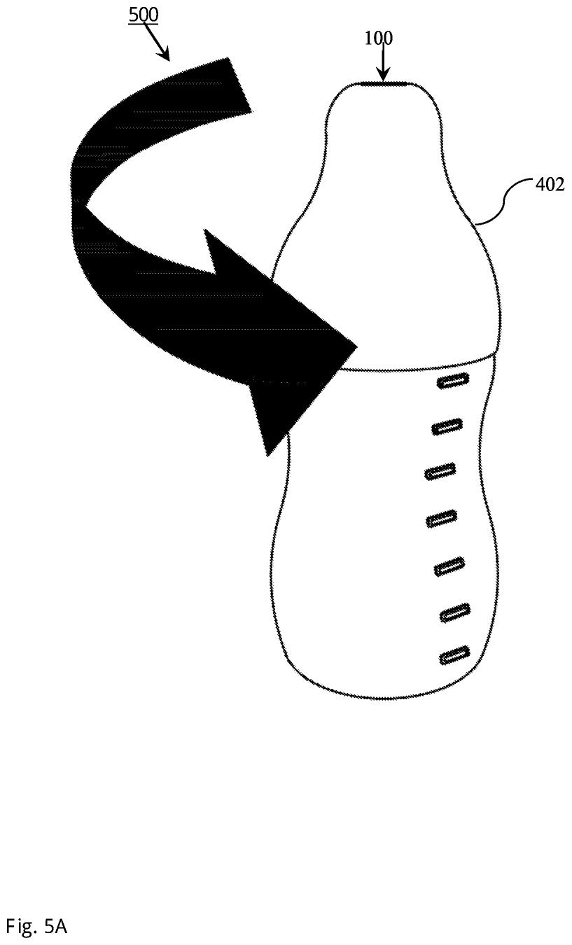

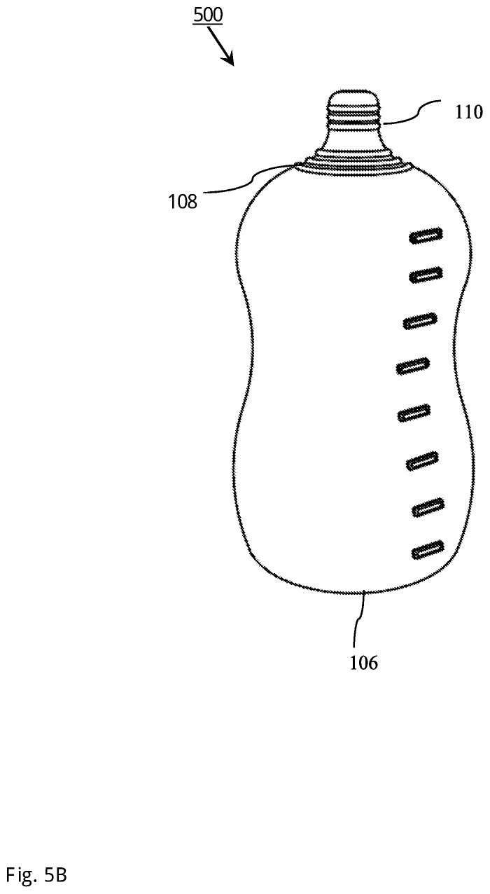

FIG. 5A illustrates a way for opening the cap 402 of the bottle 100, in accordance with an embodiment of the present invention. Herein, a twist off tab may open the teat 110. The twist off may fit into the cap and the cap may twist, the twist off opens and stays inside the cap. Also, the cap 402 may be sterilised prior to fitting over the twist off. Further, the cap 402 may be twisted in an anticlockwise direction on an axis of the bottle 100. The cap 402 may be twisted in order to open the bottle 100 for use. In addition, an outer portion of the teat 110 stays sterile before baby sucks from the teat 110. Further, the bottle 100 after opening of the cap 402 is illustrated in FIG. 5B, in accordance with an embodiment 500 of the present invention.

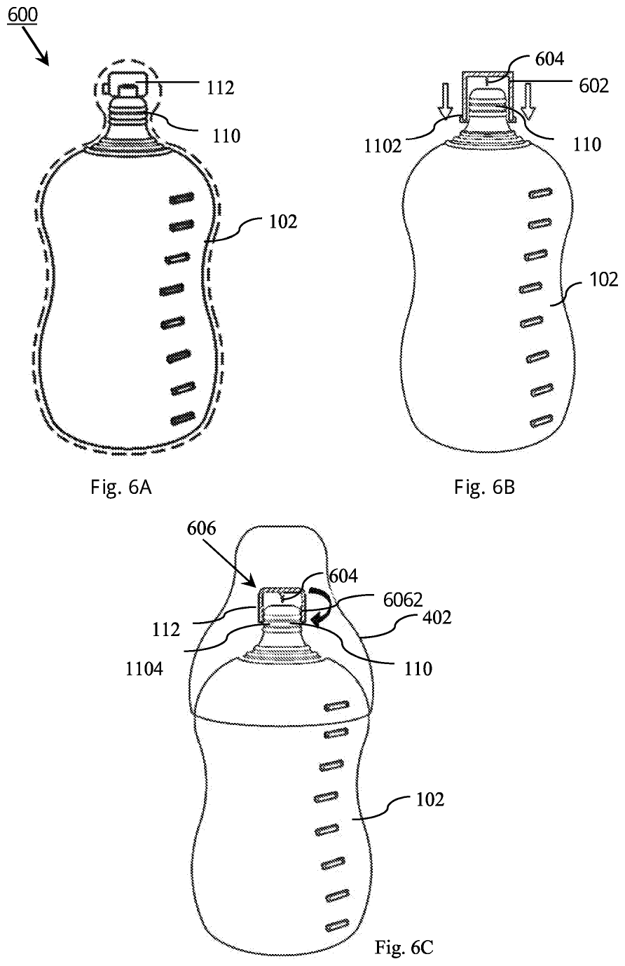

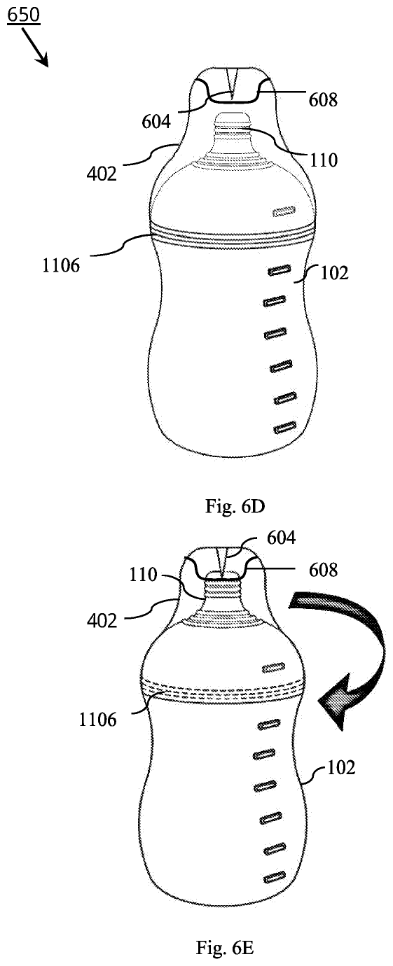

FIG. 6A illustrates the twist type closure 112 of the bottle 100, in accordance with an embodiment 600 of the present invention. The twist type closure 112 covers the teat 110. To remove the twist type closure 112, a user may twist the twist type closure 112 in clockwise or anti-clockwise direction and pull the twist type closure 112 off the bottle 100. FIG. 6B illustrates a puncture type closure 602 of the bottle 100, in accordance with an embodiment 600 of the present invention. Herein, a sharpened projection 604 is provided inside the puncture type closure 602. Further, the puncture type closure 602 rests on a breakable attachment extending from the teat 110. The breakable attachment 1102 is configured to hold the puncture type closure 602 in a position such that the puncture type closure 602 covers the teat 110. The user may push the puncture type closure 602 to tamper the breakable attachment 1102 and move the sharpened projection 604 towards the teat 110. The sharpened projection 604 may create a hole in the teat 110 so that baby may suck the liquid easily.

FIG. 6C illustrates a twist and puncture type closure 606 of the bottle 100, in accordance with an embodiment 600 of the present invention. Herein, external threads 1104 are provided on the outer surface of the teat 110. Also, the twist and puncture type closure 606 includes internal threads 6062 configured to mesh with the external threads 1104 of the teat 110. This keeps the twist and puncture type closure 606 attached with the teat 110 and keeps the teat 110 covered. The twist and puncture type closure 606 may be twisted over the external threads 1104 in a clockwise direction to move the sharpened projection 604 towards the teat 110. The sharpened projection 604 may create a hole in the teat 110 so that baby may suck the liquid easily. The twist and puncture type closure 606 is enclosed within the cap 402.

FIGS. 6D and 6E illustrate a second twist and puncture type closure 608 for the bottle 100, in accordance with another embodiment 650 of the present invention. As shown in FIG. 6D, the sharpened projection 604 and the second twist and puncture type closure 608 are formed within the cap 402 that is thread moulded to the bottle 100 having threads 1106. When the cap 402 is twisted along the threads 1106, the sharpened projection 604 is driven into the teat 110, as shown in FIG. 6E. The depth and opening diameter of the teat 110 are altered by changing how far the cap 402 is twisted. Twists can include, but not limited to, ⅛ turn, ¼ turn, ⅜ turn and the like and to suit a desired application.

In any of the types of the closures 112, and the manners in which they can be used to open the teat 110, as discussed above by means of FIG. 6A to 6C, the closures 112 are removed after the teat 110 has been opened, and we are left with the bottle 100 with open teat 110 at that top end 108.

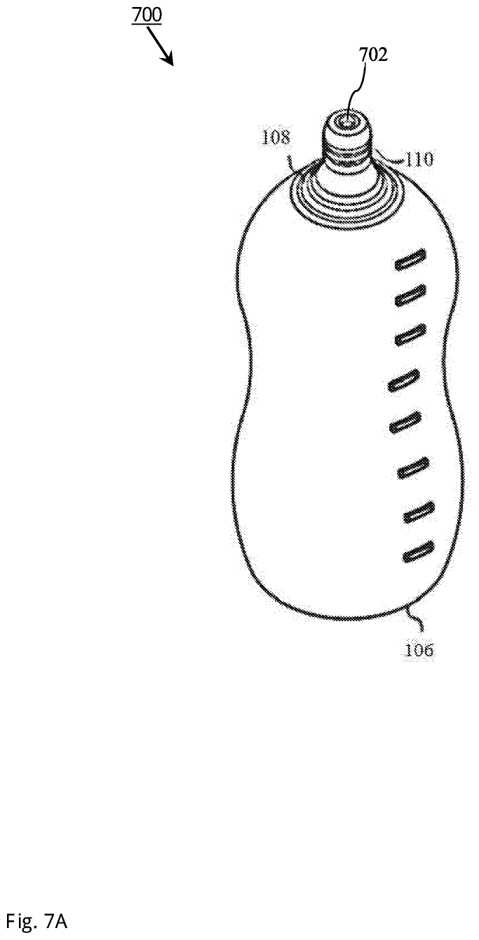

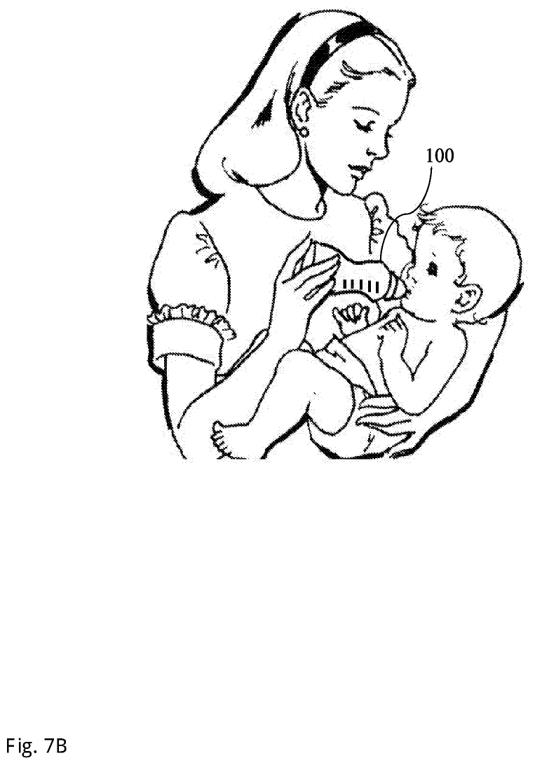

FIG. 7A illustrates the bottle 100 after opening the teat 110 using the closure 112, in accordance with an embodiment 700 of the present invention. As shown in FIG. 7A, the teat 110 may be opened using any type of closure 112 described above. Open teat 110 now includes a hole 702 through which the liquid contained in the bottle 100 can pass through in order to be fed to the baby. Once the bottle 100 is opened, the teat 110 is inserted into the mouth of the baby and hence feeding takes place as shown in FIG. 7B.

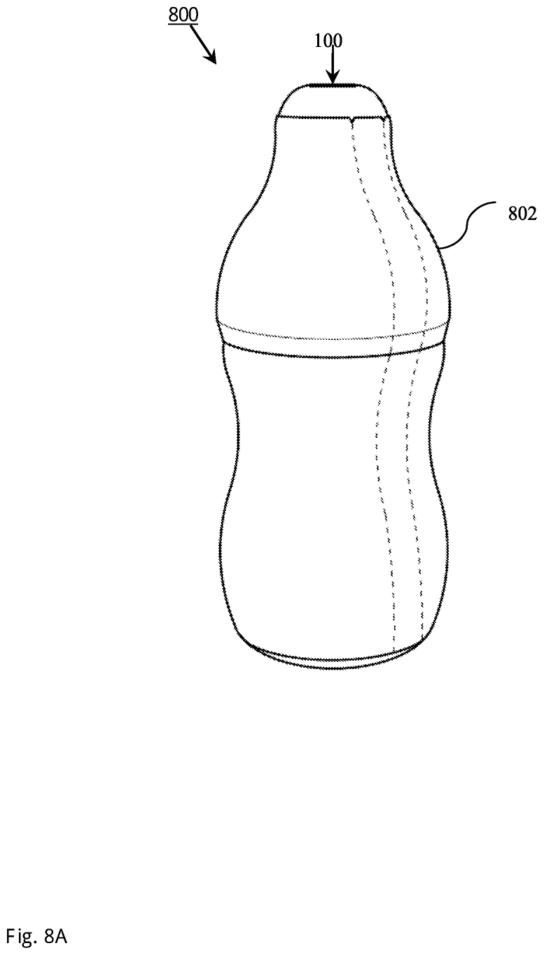

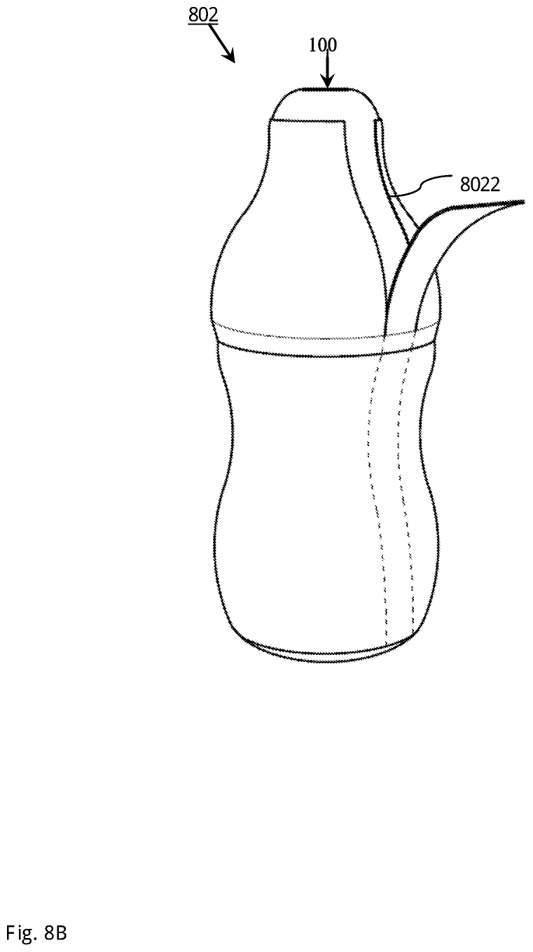

FIG. 8A illustrates the bottle 100 for feeding enclosed in a cover 802, in accordance with an embodiment 800 of the present invention. As shown in FIG. 8A, the cover 802 may include certain characteristics such as, but not limited to, being dust proof, durable and anti-bacterial, light weight, comfortable, UV light resistant and insulated. Further, referring to FIG. 8B that illustrates a way of removing the cover 802 from the bottle 100, in accordance with an embodiment 800 of the present invention. The cover 802 may include an opening mechanism 8022, such as a zipper, that can be opened effortlessly. The zipper material may be a plastic material or a metallic material. Also, the cover 802 may be detached easily and may be washed with mild detergent. Additionally, the cover 802 may be prepared in a convenient shape in order to fit different sizes of the bottle 100. In another embodiment the cover is a sleeve that is plastic or material that is shrunk around the bottle. The cover or sleeve may perform a number of functions including to: provide an appropriate degree of tamper evidence; to prevent the re-closeable cap from being inadvertently being dislodged; to prevent the bottle tab from being broken an inadvertently opening the bottle; to provide all product artwork, nutritional information, usage instructions, batch and expiry (shelf life) information as may be required by law. The sleeve may be opened using perforations on the sleeve that assist in opening the sleeve when the user wishes to open the bottle. The perforations assist in tearing open the sleeve along the line of perforations.

The bottle 100 for feeding offers a number of advantages. The bottle 100 for feeding is beneficial for mothers who are unable to read the instructions written on the available bottles. Also, a mother knows exactly what her baby's intake of milk is or how much milk her baby has had. Additionally, the mother need not to be present each time the baby has to be fed; some other family member or friend can also feed the baby. Moreover, a social life of the mother does not need to be curtailed. She can resume her normal life by using bottle-feeding. Also, the bottle 100 for feeding is convenient while travelling or out Furthermore, the bottle 100 for feeding eliminates the need of expensive logistics such as, but not limited to, cleaning and sterilization of bottles which is a time consuming process. Additionally, the bottle 100 for feeding is used in emergency situations, disaster, hospitals or the like wherein the feeding can commence quickly. Also, the bottle 100 for feeding can potentially be heated in a microwave and/or hot water to heat the liquid present in the bottle 100. Moreover, the teat 110 can be adapted as necessary i.e. for different ages, possibly to assist with different feeding problems etc. In addition, the method 200 of manufacturing the bottle 100 feeding may allow for a much wider variety of sizes, shapes and neck openings. The above method of producing the bottle 100 may be less expensive and may be less time consuming.

In use, the user selects the bottle 100 they wish to feed the baby and warm it up as necessary. Alternatively, the bottle 100 can be given to the baby at room temperature or cooled. The user actuates the appropriate closure 112 for the bottle 100 to prepare the teat 110 for feeding. Upon actuating the closure 112, the teat 110 is opened either by twisting the closure 112 in the embodiment shown in FIG. 6A or pierced by the projection 602 in the embodiment shown in FIG. 6B and FIG. 6C. For other embodiments the specific manner of preparing the teat 110 and making an opening therein through which the liquid in the bottle 100 can be fed to the baby through the teat 110 may change. Once prepared the teat 110 is the inserted into the mouth of the baby and feeding takes place as normal.

While the embodiments discussed herein relate to the feeding of human infants and babies, the invention is not limited to this application. Embodiments of the invention can be used for veterinary applications, i.e. the feeding of animals. It should be understood that the teat 110, body 102 and closure 112 can be modified to suit the animal and specific application.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the disclosure is anticipated to hold on to all other such alternatives, modifications, and variations that fall within the scope of the present disclosure and appended claims.

1-22. (canceled)

23. A bottle for feeding, the bottle comprising:
a body defining an enclosed cavity, the body having a base and a top end, the enclosed cavity having pre-mixed and pre-filled formula;
a teat provided at the top end, the teat being adapted for discharging the formula, in use; and
a closure provided on the teat, being adapted for hermetically and aseptically sealing the teat, before use and after the bottle has been manufactured wherein the body, the teat and the closure are provided in a single combined moulded form and wherein the closure is a twist type closure.

24. The bottle as claimed in claim 23, further comprising an insulated cover provided onto the bottle.

25. The bottle as claimed in claim 24, wherein the insulated cover comprises an opening mechanism.

26. The bottle as claimed in claim 25, wherein the opening mechanism is a zipper.

27. The bottle as claimed in claim 26, wherein the zipper material is selected from a group comprising a plastic material and a metallic material.

28. A method of manufacturing a bottle for feeding, the method comprising:
extruding a parison from fused raw material and positioning the parison in an open mould, the open mould having an upper portion and a lower portion;
closing the lower portion, the closing of the lower portion resulting in closing of the parison at one end and formation of a base of the bottle;
applying pressurized air into the parison and/or applying a vacuum to the lower portion, resulting in the parison taking a shape of the lower portion and forming a body of the bottle, the body defining an enclosed cavity;
feeding a predetermined amount of formula into the enclosed cavity; and
closing the upper portion of the mould, resulting in formation of a teat and a closure in a combined form at a top end of the bottle wherein the body, the teat and the closure are provided in a single combined moulded form and wherein the closure is a twist type closure.

29. The method as claimed in claim 28, wherein the raw material is a polymer material.

30. The method as claimed in claim 28, wherein the pressurized air is sterilized before being applied into the parison.

31. The method as claimed in claim 28, further comprising a step of providing an insulated cover onto the bottle.

32. The method as claimed in claim 30, wherein the insulated cover comprises an opening mechanism.

33. The method as claimed in claim 32, wherein the opening mechanism is a zipper.

34. The method as claimed in claim 33, wherein the zipper material is selected from a group comprising a plastic material and a metallic material.

35. A bottle for feeding, the bottle comprising:
a body defining an enclosed cavity, the body having a base and a top end, the enclosed cavity containing a liquid;
a teat provided at the top end, the teat being adapted for discharging the liquid, in use; and
a closure provided on the teat, being adapted for hermetically and aseptically sealing the teat, before use and after the bottle has been manufactured wherein the body, the teat and the closure are provided in a single combined moulded form and wherein the closure is a twist type closure.

36. A method of manufacturing a bottle for feeding, the method comprising:
extruding a parison from fused raw material and positioning the parison in an open mould, the open mould having an upper portion and a lower portion;
closing the lower portion, the closing of the lower portion resulting in closing of the parison at one end and formation of a base of the bottle;
applying pressurized air into the parison and/or applying a vacuum to the lower portion, resulting in the parison taking a shape of the lower portion and forming a body of the bottle, the body defining an enclosed cavity;
feeding a predetermined amount of liquid into the enclosed cavity; and
closing the upper portion of the mould, resulting in formation of a teat and a closure in a combined form at a top end of the bottle wherein the body, the teat and the closure are provided in a single combined moulded form and wherein the closure is a twist type closure.

37. A bottle for feeding, the bottle comprising:
body defining an enclosed cavity, the body having a base and a top end, the enclosed cavity containing a liquid;
a teat being adapted for discharging the liquid, in use; and
a closure being adapted for hermetically and aseptically sealing the teat, before use and after the bottle has been manufactured wherein the body, the teat and the closure are provided in a single combined moulded form and wherein the closure is a twist type closure.

38. A method of manufacturing a bottle for feeding, the method comprising:
extruding a parison from fused raw material and positioning the parison in an open mould, the open mould having an upper portion and a lower portion;
closing the lower portion, the closing of the lower portion resulting in closing of the parison at one end and formation of a base of the bottle;
applying pressurized air into the parison and/or applying a vacuum to the lower portion, resulting in the parison taking a shape of the lower portion and forming a body of the bottle, the body defining an enclosed cavity;
feeding a predetermined amount of formula into the enclosed cavity; closing the upper portion of the mould; forming a teat and a closure at one end of the bottle wherein the body, the teat and the closure are provided in a single combined moulded form and wherein the closure is a twist type closure.
